(19) United States
(12) Patent Application Publication
(10) Pub. No.: US 2010/0178975 A1
(43) Pub. Date: Jul. 15, 2010

(54) GRAPHICAL PROGRESS REPORT FOR GAMING DEVICE BONUS

(75) Inventor: John F. Acres, Corvallis, OR (US)

Correspondence Address: MARGER JOHNSON & MCCOLLOM, P.C., 210 SW MORRISON STREET, SUITE 400, PORTLAND, OR, 97204, US

(73) Assignee: Acres-Fiore Patents, Las Vegas, NV (US)

(21) Appl. No.: 12/353,083

(22) Filed: Jan. 13, 2009

(51) Int. Cl. A63F 9/24; A63F 13/00

(52) U.S. Cl. 463/20; 463/25

(57) ABSTRACT

Embodiments of the present invention are directed to a graphical report or progress bar that informs the player how close they are to receiving a bonus for a gaming device. In one embodiment a character “eats,” consumes, or otherwise eliminates obstacles between an avatar or indicator character and a reward. The character advances based on results of playing the base game on the gaming device or based on other factors. Reaching the reward allows the player to play another bonus game that directly awards cash, credit, or some other benefit. Progress toward the bonus award may be associated (and stored) with a player account, so that it carries over from one gaming session to another, or progress may be only active for the current session. Linked devices could remove the obstacles in either or both of the games. In other embodiments the graphical report takes form of a bar having an increasing fill level, a miner uncovering jewels from rocks, a miner extracting jewels from a mine or hole, and a pie that adds pieces as the player progresses toward the bonus.

### FIELD OF THE INVENTION

This disclosure relates generally to network gaming, and more particularly to bonusing systems on networked games.

### BACKGROUND

Networked gaming devices, such as slot machines in casinos, were introduced many years ago, with mixed successes. The gaming networks provided a platform for a variety of bonuses, such as a “progressive” bonus, which is a bonus award that accumulates a very small portion of each wager to the progressive total. The large progressive totals attract players who are enticed by the thought of winning such large amounts. When a player wins the progressive bonus it is typically a very large award, however, progressive awards are not often won.

Because progressive bonuses are awarded so infrequently many players do not garner much excitement from each individual game. In other words, although the players like the thought of the potential of winning a large bonus if he or she wins the progressive, which causes the player to play a particular game, such excitement does not necessarily translate to long gaming sessions if a players finds the games themselves to be boring, repetitive, or to not pay out frequently enough to satisfy the player. Casinos must continue to enhance the overall game experience if they wish to draw new players to games and keep the players engaged.

Embodiments of the invention address these and other limitations in the prior art.

### BRIEF DESCRIPTION OF THE DRAWINGS

FIG. 1A is a functional block diagram that illustrates a gaming device according to embodiments of the invention.

FIG. 1B is an isometric view of the gaming device illustrated in FIG. 1A.

FIGS. 2A, 2B, and 2C are detail diagrams of exemplary types of gaming devices according to embodiments of the invention.

FIG. 3 is a functional block diagram of networked gaming devices according to embodiments of the invention.

FIG. 4 is a block diagram of a gaming device illustrating a graphical bonus progress display of a bonus system according to embodiments of the invention.

FIGS. 5A and 5B illustrate another graphical bonus progress display of a bonus system according to embodiments of the invention.

FIGS. 6A and 6B illustrate yet another graphical bonus progress display of a bonus system according to embodiments of the invention.

FIG. 7 illustrates a further graphical bonus progress display of a bonus system according to embodiments of the invention.

FIGS. 8A-8C illustrate a graphical indicator of a bonus progress display as it appears at various time stages of a bonus according to embodiments of the invention.

### DETAILED DESCRIPTION

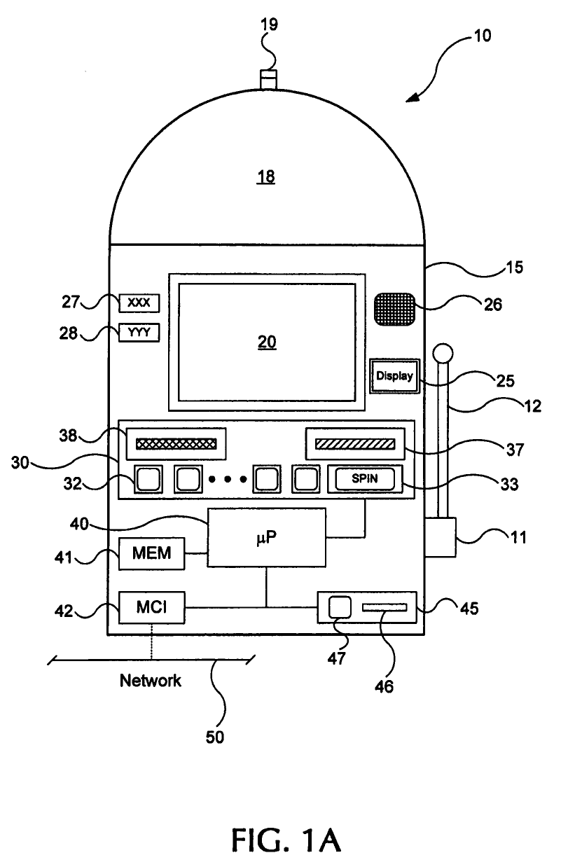

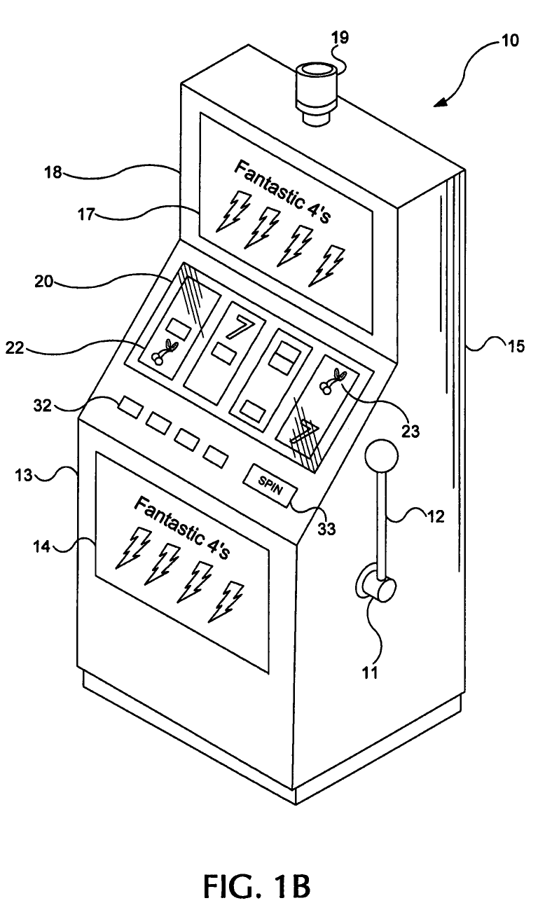

FIGS. 1A and 1B illustrate example gaming devices according to embodiments of the invention.

Referring to FIGS. 1A and 1B, a gaming device 10 is an electronic gaming machine. Although an electronic gaming machine or “slot” machine is illustrated, various other types of devices may be used to wager monetarily based credits on a game of chance in accordance with principles of the invention. The term “electronic gaming device” is meant to include various devices such as electromechanical spinning-reel type slot machines, video slot machines, and video poker machines, for instance. Other gaming devices may include computer-based gaming machines, wireless gaming devices, multi-player gaming stations, modified personal electronic gaming devices (such as cell phones), personal computers, server-based gaming terminals, and other similar devices. Although embodiments of the invention will work with all of the gaming types mentioned, for ease of illustration the present embodiments will be described in reference to the electronic gaming machine 10 shown in FIGS. 1A and 1B.

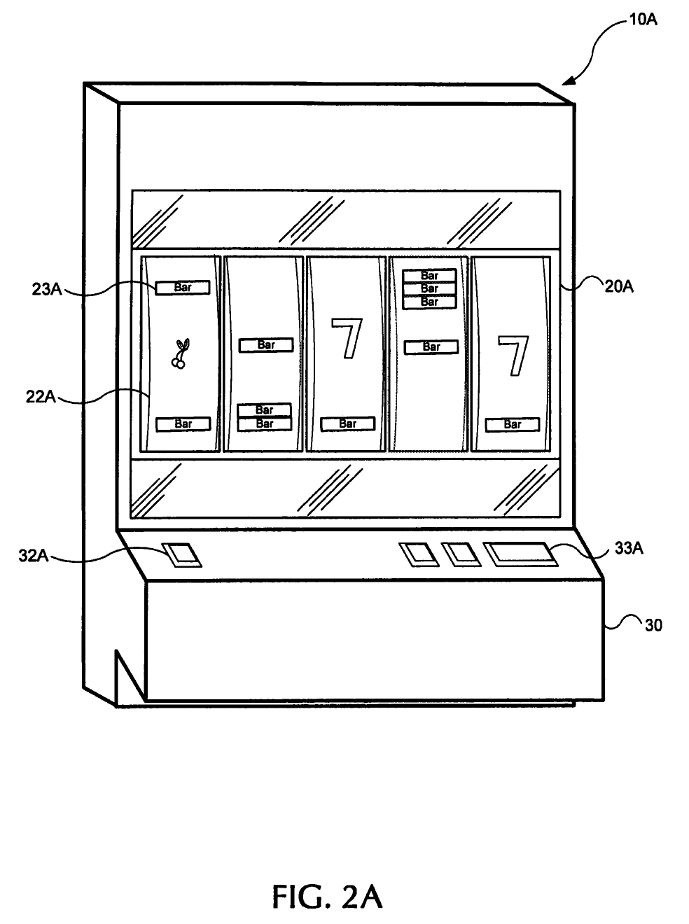

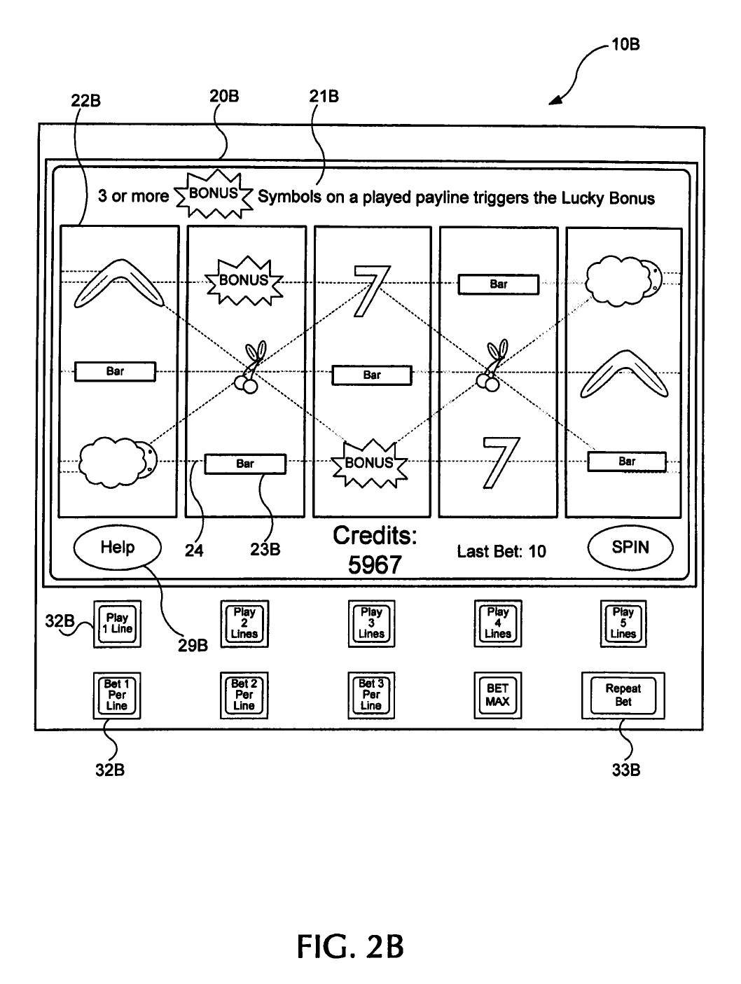

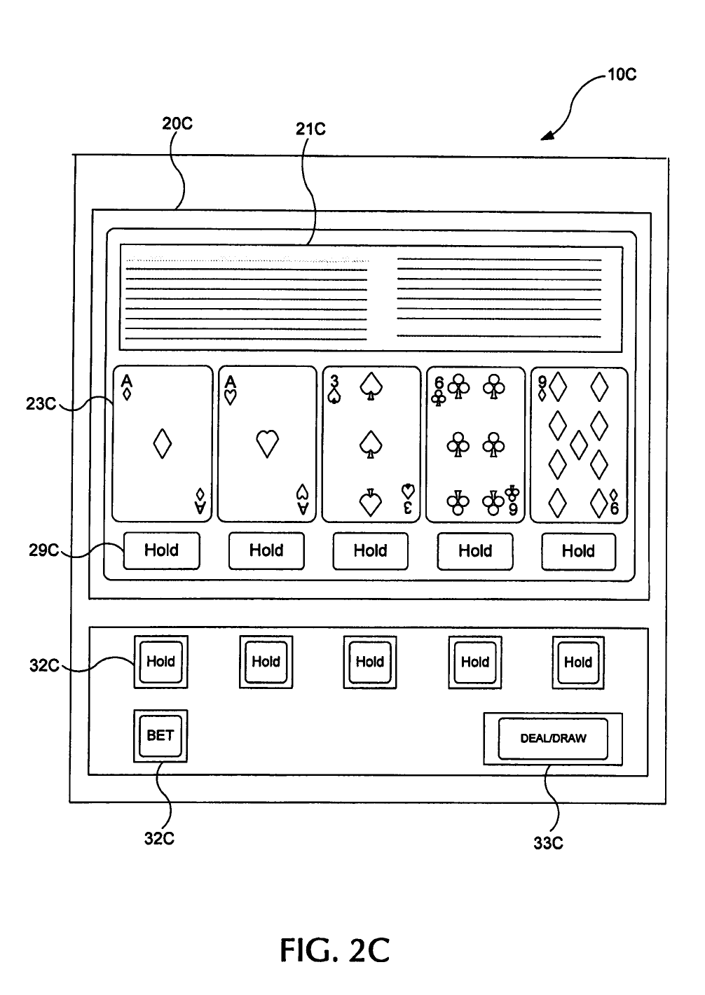

The gaming device 10 includes a cabinet 15 housing components to operate the gaming device 10. The cabinet 15 may include a gaming display 20, a base portion 13, a top box 18, and a player interface panel 30. The gaming display 20 may include mechanical spinning reels (FIG. 2A), a video display (FIGS. 2B and 2C), or a combination of both spinning reels and a video display (not shown). The gaming cabinet 15 may also include a credit meter 27 and a coin-in or bet meter 28. The credit meter 27 may indicate the total number of credits remaining on the gaming device 10 that are eligible to be wagered. In some embodiments, the credit meter 27 may reflect a monetary unit, such as dollars. However, it is often preferable to have the credit meter 27 reflect a number of ‘credits,’ rather than a monetary unit. The bet meter 28 may indicate the amount of credits to be wagered on a particular game. Thus, for each game, the player transfers the amount that he or she wants to wager from the credit meter 27 to the bet meter 28. In some embodiments, various other meters may be present, such as meters reflecting amounts won, amounts paid, or the like. In embodiments where the gaming display 20 is a video monitor, the information indicated on the credit meters may be shown on the gaming display itself 20 (FIG. 2B).

The base portion 13 may include a lighted panel 14, a coin return (not shown), and a gaming handle 12 operable on a partially rotating pivot joint 11. The game handle 12 is traditionally included on mechanical spinning-reel games, where the handle may be pulled toward a player to initiate the spinning of reels 22 after placement of a wager. The top box 18 may include a lighted panel 17, a video display (such as an LCD monitor), a mechanical bonus device (not shown), and a candle light indicator 19. The player interface panel 30 may include various devices so that a player can interact with the gaming device 10.

The player interface panel 30 may include one or more game buttons 32 that can be actuated by the player to cause the gaming device 10 to perform a specific action. For example, some of the game buttons 32 may cause the gaming device 10 to bet a credit to be wagered during the next game, change the number of lines being played on a multi-line game, cash out the credits remaining on the gaming device (as indicated on the credit meter 27), or request assistance from casino personnel, such as by lighting the candle 19. In addition, the player interface panel 30 may include one or more game actuating buttons 33. The game actuating buttons 33 may initiate a game with a pre-specified amount of credits. On some gaming devices 10 a “Max Bet” game actuating button 33 maybe included that places the maximum credit wager on a game and initiates the game. The player interface panel 30 may further include a bill acceptor 37 and a ticket printer 38. The bill acceptor 37 may accept and validate paper money or previously printed tickets with a credit balance. The ticket printer 38 may print out tickets reflecting the balance of the credits that remain on the gaming device 10 when a player cashes out by pressing one of the game buttons 32 programmed to cause a ‘cashout.’ These tickets may be inserted into other gaming machines or redeemed at a cashier station or kiosk for cash.

The gaming device 10 may also include one or more speakers 26 to transmit auditory information or sounds to the player. The auditory information may include specific sounds associated with particular events that occur during game play on the gaming device 10. For example, a particularly festive sound may be played during a large win or when a bonus is triggered. The speakers 26 may also transmit “attract” sounds to entice nearby players when the game is not currently being played.

The gaming device 10 may further include a secondary display 25. This secondary display 25 may be a vacuum fluorescent display (VFD), a liquid crystal display (LCD), a cathode ray tube (CRT), a plasma screen, or the like. The secondary display 25 may show any combination of primary game information and ancillary information to the player. For example, the secondary display 25 may show player tracking information, secondary bonus information, advertisements, or player selectable game options.

The gaming device 10 may include a separate information window (not shown) dedicated to supplying any combination of information related to primary game play, secondary bonus information, player tracking information, secondary bonus information, advertisements or player selectable game options. This window may be fixed in size and location or may have its size and location vary temporally as communication needs change. One example of such a resizable window is International Game Technology's “service window”. Another example is Las Vegas Gaming Incorporated's retrofit technology which allows information to be placed over areas of the game or the secondary display screen at various times and in various situations.

The gaming device 10 includes a microprocessor 40 that controls operation of the gaming device 10. If the gaming device 10 is a standalone gaming device, the microprocessor 40 may control virtually all of the operations of the gaming devices and attached equipment, such as operating game logic stored in memory (not shown) as firmware, controlling the display 20 to represent the outcome of a game, communicating with the other peripheral devices (such as the bill acceptor 37), and orchestrating the lighting and sound emanating from the gaming device 10. In other embodiments where the gaming device 10 is coupled to a network 50, as described below, the microprocessor 40 may have different tasks depending on the setup and function of the gaming device. For example, the microprocessor 40 may be responsible for running the base game of the gaming device and executing instructions received over the network 50 from a bonus server or player tracking server. In a server-based gaming setup, the microprocessor 40 may act as a terminal to execute instructions from a remote server that is running game play on the gaming device.

The microprocessor 40 may be coupled to a machine communication interface (MCI) 42 that connects the gaming device 10 to a gaming network 50. The MCI 42 may be coupled to the microprocessor 40 through a serial connection, a parallel connection, an optical connection, or in some cases a wireless connection. The gaming device 10 may include memory 41 (MEM), such as a random access memory (RAM), coupled to the microprocessor 40 and which can be used to store gaming information, such as storing total coin-in statistics about a present or past gaming session, which can be communicated to a remote server or database through the MCI 42. The MCI 42 may also facilitate communication between the network 50 and the secondary display 25 or a player tracking unit 45 housed in the gaming cabinet 15.

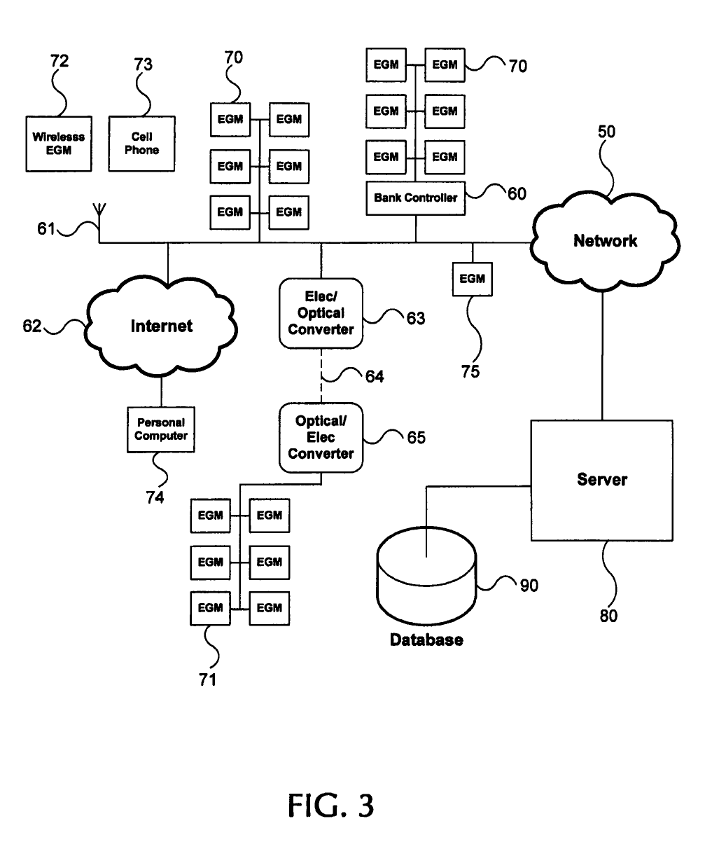

The player tracking unit 45 may include an identification device 46 and one or more buttons 47 associated with the player tracking unit 45. The identification device 46 serves to identify a player, by, for example, reading a player-tracking device, such as a player tracking card that is issued by the casino to individual players who choose to have such a card. The identification device 46 may instead, or additionally, identify players through other methods. Player tracking systems using player tracking cards and card readers 46 are known in the art. Briefly summarizing such a system, a player registers with the casino prior to commencing gaming. The casino issues a unique player-tracking card to the player and opens a corresponding player account that is stored on a server or host computer, described below with reference to FIG. 3. The player account may include the player's name and mailing address and other information of interest to the casino in connection with marketing efforts. Prior to playing one of the gaming devices in the casino, the player inserts the player tracking card into the identification device 46 thus permitting the casino to track player activity, such as amounts wagered, credits won, and rate of play.

To induce the player to use the card and be an identified player, the casino may award each player points proportional to the money or credits wagered by the player. Players typically accrue points at a rate related to the amount wagered, although other factors may cause the casino to award the player various amounts. The points may be displayed on the secondary display 25 or using other methods. In conventional player tracking systems, the player may take his or her card to a special desk in the casino where a casino employee scans the card to determine how many accrued points are in the player's account. The player may redeem points for selected merchandise, meals in casino restaurants, or the like, which each have assigned point values. In some player tracking systems, the player may use the secondary display 25 to access their player tracking account, such as to check a total number of points, redeem points for various services, make changes to their account, or download promotional credits to the gaming device 10. In other embodiments, the identification device 46 may read other identifying cards (such as driver licenses, credit cards, etc.) to identify a player and match them to a corresponding player tracking account. Although FIG. 1A shows the player tracking unit 45 with a card reader as the identification device 46, other embodiments may include a player tracking unit 45 with a biometric scanner, PIN code acceptor, or other methods of identifying a player to pair the player with their player tracking account.

During typical play on a gaming device 10, a player plays a game by placing a wager and then initiating a gaming session. The player may initially insert monetary bills or previously printed tickets with a credit value into the bill acceptor 37. The player may also put coins into a coin acceptor (not shown) or a credit, debit or casino account card into a card reader/authorizer (not shown). One of skill in the art will readily see that this invention is useful with all gambling devices, regardless of the manner in which wager value-input is accomplished.

The credit meter 27 displays the numeric credit value of the money inserted dependent on the denomination of the gaming device 10. That is, if the gaming device 10 is a nickel slot machine and a $20 bill inserted into the bill acceptor 37, the credit meter will reflect 400 credits or one credit for each nickel of the inserted twenty dollars. For gaming devices 10 that support multiple denominations, the credit meter 27 will reflect the amount of credits relative to the denomination selected. Thus, in the above example, if a penny denomination is selected after the $20 is inserted the credit meter will change from 400 credits to 2000 credits.

A wager may be placed by pushing one or more of the game buttons 32, which may be reflected on the bet meter 28. That is, the player can generally depress a “bet one” button (one of the buttons on the player interface panel 30, such as 32), which transfers one credit from the credit meter 27 to the bet meter 28. Each time the button 32 is depressed an additional single credit transfers to the bet meter 28 up to a maximum bet that can be placed on a single play of the electronic gaming device 10. The gaming session may be initiated by pulling the gaming handle 12 or depressing the spin button 33. On some gaming devices 10, a “max bet” button (another one of the buttons 32 on the player interface panel 30) may be depressed to wager the maximum number of credits supported by the gaming device 10 and initiate a gaming session.

If the gaming session does not result in any winning combination, the process of placing a wager may be repeated by the player. Alternatively, the player may cash out any remaining credits on the credit meter 27 by depressing the “cash-out” button (another button 32 on the player interface panel 30), which causes the credits on the credit meter 27 to be paid out in the form of a ticket through the ticket printer 38, or may be paid out in the form of returning coins from a coin hopper (not shown) to a coin return tray.

If instead a winning combination (win) appears on the display 20, the award corresponding to the winning combination is immediately applied to the credit meter 27. For example, if the gaming device 10 is a slot machine, a winning combination of symbols 23 may land on a played payline on reels 22. If any bonus games are initiated, the gaming device 10 may enter into a bonus mode or simply award the player with a bonus amount of credits that are applied to the credit meter 27.

FIGS. 2A to 2C illustrate exemplary types of gaming devices according to embodiments of the invention. FIG. 2A illustrates an example spinning-reel gaming machine 10A, FIG. 2B illustrates an example video slot machine 10B, and FIG. 2C illustrates an example video poker machine 10C.

Referring to FIG. 2A, a spinning-reel gaming machine 10A includes a gaming display 20A having a plurality of mechanical spinning reels 22A. Typically, spinning-reel gaming machines 10A have three to five spinning reels 22A. Each of the spinning reels 22A has multiple symbols 23A that may be separated by blank areas on the spinning reels 22A, although the presence of blank areas typically depends on the number of reels 22A present in the gaming device 10A and the number of different symbols 23A that may appear on the spinning reels 22A. Each of the symbols 22A or blank areas makes up a “stop” on the spinning reel 22A where the reel 22A comes to rest after a spin. Although the spinning reels 22A of various games 10A may have various numbers of stops, many conventional spinning-reel gaming devices 10A have reels 22A with twenty two stops.

During game play, the spinning reels 22A may be controlled by stepper motors (not shown) under the direction of the microprocessor 40 (FIG. 1A). Thus, although the spinning-reel gaming device 10A has mechanical based spinning reels 22A, the movement of the reels themselves is electronically controlled to spin and stop. This electronic control is advantageous because it allows a virtual reel strip to be stored in the memory 41 of the gaming device 10A, where various “virtual stops” are mapped to each physical stop on the physical reel 22A. This mapping allows the gaming device 10A to establish greater awards and bonuses available to the player because of the increased number of possible combinations afforded by the virtual reel strips.

A gaming session on a spinning reel slot machine 10A typically includes the player pressing the “bet-one” button (one of the game buttons 32A) to wager a desired number of credits followed by pulling the gaming handle 12 (FIGS. 1A, 1B) or pressing the spin button 33A to spin the reels 22A. Alternatively, the player may simply press the “max-bet” button (another one of the game buttons 32A) to both wager the maximum number of credits permitted and initiate the spinning of the reels 22A. The spinning reels 22A may all stop at the same time or may individually stop one after another (typically from left to right) to build player anticipation. Because the display 20A usually cannot be physically modified, some spinning reel slot machines 10A include an electronic display screen in the top box 18 (FIG. 1B), a mechanical bonus mechanism in the top box 18, or a secondary display 25 (FIG. 1A) to execute a bonus.

Referring to FIG. 2B, a video gaming machine 10B may include a video display 20B to display virtual spinning reels 22B and various other gaming information 21B. The video display 20B may be a CRT, LCD, plasma screen, or the like. It is usually preferable that the video display 20B be a touchscreen to accept player input. A number of symbols 23A appear on each of the virtual spinning reels 22B. Although FIG. 2B shows five virtual spinning reels 22B, the flexibility of the video display 20B allows for various reel 22B and game configurations. For example, some video slot games 10B spin reels for each individual symbol position (or stop) that appears on the video display 20B. That is, each symbol position on the screen is independent of every other position during the gaming sessions. In these types of games, very large numbers of pay lines or multiple super scatter pays can be utilized since similar symbols could appear at every symbol position on the video display 20B. On the other hand, other video slot games 10B more closely resemble the mechanical spinning reel games where symbols that are vertically adjacent to each other are part of the same continuous virtual spinning reel 22B.

Because the virtual spinning reels 22B, by virtue of being computer implemented, can have almost any number of stops on a reel strip, it is much easier to have a greater variety of displayed outcomes as compared to spinning-reel slot machines 10A (FIG. 2A) that have a fixed number of physical stops on each spinning reel 22A.

With the possible increases in reel 22B numbers and configurations over the mechanical gaming device 10A, video gaming devices 10B often have multiple paylines 24 that may be played. By having more paylines 24 available to play, the player may be more likely to have a winning combination when the reels 22B stop and the gaming session ends. However, since the player typically must wager at least a minimum number of credits to enable each payline 24 to be eligible for winning, the overall odds of winning are not much different, if at all, than if the player is wagering only on a single payline. For example, in a five line game, the player may bet one credit per payline 24 and be eligible for winning symbol combinations that appear on any of the five played paylines 24. This gives a total of five credits wagered and five possible winning paylines 24. If, on the other hand, the player only wagers one credit on one payline 24, but plays five gaming sessions, the odds of winning would be identical as above: five credits wagered and five possible winning paylines 24.

Because the video display 20B can easily modify the image output by the video display 20B, bonuses, such as second screen bonuses are relatively easy to award on the video slot game 10B. That is, if a bonus is triggered during game play, the video display 20B may simply store the resulting screen shot in memory and display a bonus sequence on the video display 20B. After the bonus sequence is completed, the video display 20B may then retrieve the previous screen shot and information from memory, and re-display that image.

Also, as mentioned above, the video display 20B may allow various other game information 21B to be displayed. For example, as shown in FIG. 2B, banner information may be displayed above the spinning reels 22B to inform the player, perhaps, which symbol combination is needed to trigger a bonus. Also, instead of providing a separate credit meter 27 (FIG. 1A) and bet meter 28, the same information can instead be displayed on the video display 20B. In addition, “soft buttons” 29B such as a “spin” button or “help/see pays” button may be built using the touch screen video display 20B. Such customization and ease of changing the image shown on the display 20B adds to the flexibility of the game 10B.

Even with the improved flexibility afforded by the video display 20B, several physical buttons 32B and 33B are usually provided on video slot machines 10B. These buttons may include game buttons 32B that allow a player to choose the number of paylines 24 he or she would like to play and the number of credits wagered on each payline 24. In addition, a max bet button (one of the game buttons 32B) allows a player to place a maximum credit wager on the maximum number of available paylines 24 and initiate a gaming session. A repeat bet or spin button 33B may also be used to initiate each gaming session when the max bet button is not used.

Referring to FIG. 2C, a video poker gaming device 10C may include a video display 20C that is physically similar to the video display 20B shown in FIG. 2B. The video display 20C may show a poker hand of five cards 23C and various other player information 21C including a paytable for various winning hands, as well as a plurality of player selectable soft buttons 29C. The video display 20C may present a poker hand of five cards 23C and various other player information 21C including a number of player selectable soft (touch-screen) buttons 29C and a paytable for various winning hands. Although the embodiment illustrated in FIG. 3C shows only one hand of poker on the video display 20C, various other video poker machines 10C may show several poker hands (multi-hand poker). Typically, video poker machines 10C play “draw” poker in which a player is dealt a hand of five cards, has the opportunity to hold any combination of those five cards, and then draws new cards to replace the discarded ones. All pays are usually given for winning combinations resulting from the final hand, although some video poker games 10C may give bonus credits for certain combinations received on the first hand before the draw. In the example shown in FIG. 2C a player has been dealt two aces, a three, a six, and a nine. The video poker game 10C may provide a bonus or payout for the player having been dealt the pair of aces, even before the player decides what to discard in the draw. Since pairs, three of a kind, etc. are typically needed for wins, a player would likely hold the two aces that have been dealt and draw three cards to replace the three, six, and nine in the hope of receiving additional aces or other cards leading to a winning combination with a higher award amount. After the draw and revealing of the final hand, the video poker game 10C typically awards any credits won to the credit meter.

The player selectable soft buttons 29C appearing on the screen respectively correspond to each card on the video display 20C. These soft buttons 29C allow players to select specific cards on the video display 20C such that the card corresponding to the selected soft button is “held” before the draw. Typically, video poker machines 10C also include physical game buttons 32C that correspond to the cards in the hand and may be selected to hold a corresponding card. A deal/draw button 33C may also be included to initiate a gaming session after credits have been wagered (with a bet button 32C, for example) and to draw any cards not held after the first hand is displayed.

Although examples of a spinning reel slot machine 10A, a video slot machine 10B, and a video poker machine 10C have been illustrated in FIGS. 2A-2C, gaming machines and various other types of gaming devices known in the art are contemplated and are within the scope of the invention.

FIG. 3 is a block diagram illustrating networked gaming devices according to embodiments of the invention. Referring to FIG. 3, multiple electronic gaming devices (EGMs) 70, 71, 72, 73, 74, and 75 may be coupled to one another and coupled to a remote server 80 through a network 50. For ease of understanding, gaming devices or EGMs 70, 71, 72, 73, 74, and 75 are generically referred to as EGMs 70-75. The term EGMs 70-75, however, may refer to any combination of one or more of EGMs 70, 71, 72, 73, 74, and 75. Additionally, the gaming server 80 may be coupled to one or more gaming databases 90. These gaming network 50 connections may allow multiple gaming devices 70-75 to remain in communication with one another during particular gaming modes such as tournament play or remote head-to-head play. Although some of the gaming devices 70-75 coupled on the gaming network 50 may resemble the gaming devices 10, 10A, 10B, and 10C shown in FIGS. 1A-1B and 2A-2C, other coupled gaming devices 70-75 may include differently configured gaming devices. For example, the gaming devices 70-75 may include traditional slot machines 75 directly coupled to the network 50, banks of gaming devices 70 coupled to the network 50, banks of gaming devices 70 coupled to the network through a bank controller 60, wireless handheld gaming machines 72 and cell phones 73 coupled to the gaming network 50 through one or more wireless routers or antennas 61, personal computers 74 coupled to the network 50 through the internet 62, and banks of gaming devices 71 coupled to the network through one or more optical connection lines 64. Additionally, some of the traditional gaming devices 70, 71, and 75 may include electronic gaming tables, multi-station gaming devices, or electronic components operating in conjunction with non-gaming components, such as automatic card readers, chip readers, and chip counters, for example.

Gaming devices 71 coupled over an optical line 64 may be remote gaming devices in a different location or casino. The optical line 64 may be coupled to the gaming network 50 through an electronic to optical signal converter 63 and may be coupled to the gaming devices 71 through an optical to electronic signal converter 65. The banks of gaming devices 70 coupled to the network 50 may be coupled through a bank controller 60 for compatibility purposes, for local organization and control, or for signal buffering purposes. The network 50 may include serial or parallel signal transmission lines and carry data in accordance with data transfer protocols such as Ethernet transmission lines, Rs-232 lines, firewire lines, USB lines, or other communication protocols. Although not shown in FIG. 3, substantially the entire network 50 may be made of fiber optic lines or may be a wireless network utilizing a wireless protocol such as IEEE 802.11 a, b, g, or n, Zigbee, RF protocols, optical transmission, near-field transmission, or the like.

As mentioned above, each gaming device 70-75 may have an individual processor 40 (FIG. 1A) and memory 41 to run and control game play on the gaming device 70-75, or some of the gaming devices 70-75 may be terminals that are run by a remote server 80 in a server based gaming environment. Server based gaming environments may be advantageous to casinos by allowing fast downloading of particular game types or themes based on casino preference or player selection. Additionally, tournament based games, linked games, and certain game types, such as BINGO or keno may benefit from at least some server 80 based control.

Thus, in some embodiments, the network 50, server 80, and database 90 may be dedicated to communications regarding specific game or tournament play. In other embodiments, however, the network 50, server 80, and database 90 may be part of a player tracking network. For player tracking capabilities, when a player inserts a player tracking card in the card reader 46 (FIG. 1A), the player tracking unit 45 sends player identification information obtained on the card reader 46 through the MCI 42 over the network 50 to the player tracking server 80, where the player identification information is compared to player information records in the player database 90 to provide the player with information regarding their player account or other features at the gaming device 10 where the player is wagering. Additionally, multiple databases 90 and/or servers 80 may be present and coupled to one or more networks 50 to provide a variety of gaming services, such as both game/tournament data and player tracking data.

The various systems described with reference to FIGS. 1-3 can be used in a number of ways. For instance, the systems can be used to track data about various players. The tracked data can be used by the casino to provide additional benefits to players, such as extra bonuses or extra benefits such as bonus games and other benefits as described above. These added benefits further entice the players to play at the casino that provides the benefits.

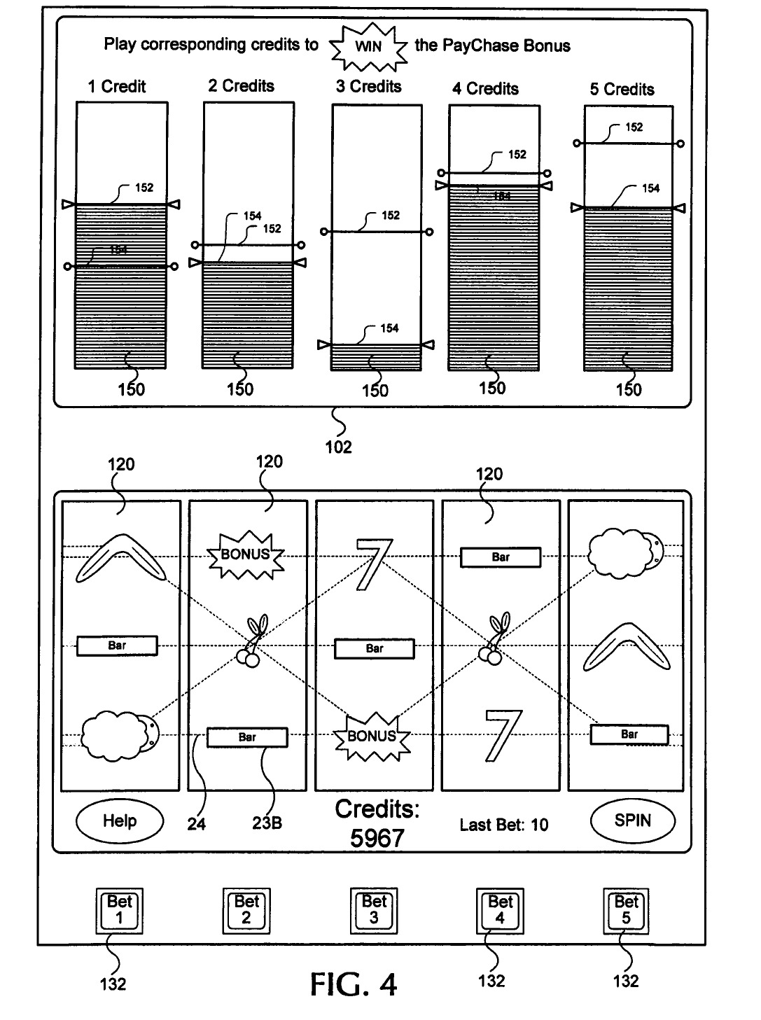

FIG. 4 is a block diagram of a bonus system or bonus game 100 that can be played on a gaming device 10 in FIG. 1. The bonus game 100 is preferably separate and distinct from the main game played on the gaming device 10, although actions the player takes in the base game may be related to the bonus game 100, as described below. In other embodiments the bonus game 100 is an integral part of the base game. The below-described bonus is designed to be played on a group of linked gaming devices, but could also be implemented as a stand-alone bonus game. With reference back to FIG. 3, a bank controller 60 is coupled to a number of EGMs 70 all within the same bank. FIG. 3 also separately shows EGMs 70 coupled to one another in a bank without use of the bank controller 60. Embodiments of the invention are best exemplified when a group of connected gaming devices 70 are located physically near one another, which can build excitement for the nearby players, as described below. In some embodiments on a casino floor, multiple separate bonus games 100 could each be operating, one for each bank or bank portion of the connected gaming devices 70.

With reference back to FIG. 4, a main bonus screen 102, which may be shown on an LCD or other display panel, can be located in the top box 18 of FIG. 1A. Also illustrated in FIG. 4 are a set of reels on a gaming display 120 and a set of game buttons 132. Operating the bonus game 100 on a reel game is just an example embodiment, and the bonus can be operated in conjunction with any type of game, such as those described above. As described above, in play, a player bets a particular wager using the game buttons 132. Game play then commences and a base game outcome is determined.

An initial portion of the bonus game 100 for connected gaming devices 70 described herein centers around the main bonus screen 102. The bonus game 100 includes a set of counters 150, each aligning with one of the bet options of the game buttons 132. For example, one of the counters is associated with the “bet-1” action. Thus, when the player presses the bet-1 button on the base game, or otherwise bets one credit, the 1-credit counter 150 is incremented. Each of the counters 150 includes a present level line 152, as illustrated in FIG. 4. The present level line 152, which is separate for each counter 150, increments each time a particular corresponding wager is made by any of the players of connected gaming devices 70 in their respective games. For example, if there are ten gaming devices 70 coupled to one another, the main bonus screen 102 will look identical, with the same counters 150 and present level lines 152 on each of the ten machines. When any of the players of the connected gaming devices 70 bet 1, the bet-1 counter 150 on each of the main bonus screens 102 increments for all the respective gaming devices 70 and the new present level line is reflected on all the main bonus screens 102 on all the coupled gaming devices.

Also illustrated in FIG. 4 is an indicator 154 on each counter 150 that shows to the player the previous satisfied trigger level that triggered the bonus round for the particular counter. Each of the counters 150 on the example bonus screen 102 includes its own present level line 152 and its own previously satisfied trigger indicator 154, although such implementation details are left to the game designer. For instance, in some embodiments the previously satisfied trigger indicator level may not be displayed at all.

Each of the counters 150 on the bonus screen 102 additionally includes a “present” or “current” trigger level, which is not shown to any players of the connected gaming devices 70. The present trigger level is the increment level at which the counter 150 triggers the next phase of the bonus 100. In some embodiments, these trigger levels are randomly set each time the previous trigger is satisfied. In other words, for example, if the bet-2 counter 150 was last triggered at “122,” the new trigger level may be randomly set to anywhere between the minimum of “1” and a maximum of, for example “175.” The new trigger level is then the new level to which the bet-2 counter 150 must reach to trigger the bonus 100 again.

In some embodiments, the triggers are not completely randomly set, but instead are weighted to cause them to trend toward a particular target or target range. One method of producing a quasi-random trigger is to set the final trigger as the sum of two components. The first component is a random number but the second component has the effect of forcing the resulting trigger into a particular region of the counter. For example, each counter may be broken into five different regions: 1-35 (A), 36-70 (B), 71-105 (C), 106-140 (D), and 141-175 (E) where the second component is the region base number to which the random generated number is added to produce the final trigger result. Such a system is illustrated in Table 1. In Table 1 the randomly generated number is selected between 1 and 35, while the second number is the base number of the weighted region, e.g. 0 for A, 35 for B, etc. As illustrated in Table 1, the region D is purposefully over-represented from its normal random distribution.

TABLE 1

| Random | Region | Trigger Result |
|---|---|---|
| 28 | A (0) | 28 |
| 20 | D (105) | 125 |
| 12 | C (70) | 82 |
| 31 | D (105) | 136 |
| 3 | E (140) | 143 |
| 15 | B (35) | 50 |
| 30 | D (105) | 140 |
| 32 | B (35) | 67 |
| 11 | C (70) | 81 |
| 5 | E (140) | 145 |

Over representing a particular region or regions from its statistical norm will bias the resulting trigger toward the desired range, while keeping the actual trigger result random within that range. There are a myriad number of methods known in the art to implement a quasi-random trigger generator to cause a desired effect and the above example is but one of them.

In the bonus 100, each of the triggers is set somewhere between the first count of the counter, i.e., 1, and the highest possible count of the counter, which may be, e.g., 200. The highest possible count of the counter 150 is the top of the box that contains the counter 150, which is indicated on the bonus screen 102. Therefore a player may be more inclined to make bets that cause a particular counter 150 to go up as it nears the top of the counter, because the bonus is guaranteed to be triggered before the counter reaches the absolute top. In this way, graphical feedback is provided to the player of progress toward the bonus or bonuses in the bonus system 100.

As mentioned above, in some embodiments the bonus screen 102 includes both the present level line 152 and the previous satisfied trigger indicator 154. Because each trigger level is randomly or quasi-randomly set, in some cases the present level line 152 may be above the previously satisfied trigger indicator 154. Such a situation is illustrated with the credit-1 counter 150 of FIG. 4. In other cases, the previous satisfied trigger indicator will be above the actual present level line 152 of the counter. Such examples are shown in counters 2, 3, 4 ,and5.

In an alternate embodiment, instead of including a counter for each of the “bet-x” options, where “x” stands for any of the possible wagers, embodiments of the invention may include a single counter that is incremented when any of the linked gaming devices 70 makes any wager. In still another embodiment, there may be only two counters, one for bet-1, bet-2, bet-3, and bet-4, and a separate counter for the bet-5 option. The remainder of the bonus 100 in these embodiments would be the same or similar to that described herein.

In operation, each of the players of the linked gaming devices 70 plays the base game betting one through five credits as desired. If a player sees that one particular counter 150 is nearing the top, or if they are simply feeling lucky, they may bet an amount that corresponds to the particular counter 150. In other instances, the player may simply make the corresponding bet in the base game without reference to the bonus game 100. Eventually, one of the players of the connected gaming devices 70 will satisfy the corresponding trigger for one of the particular counters 150. When that happens, an indicator, such as a sound, image, or series of images, or combination, may indicate to players of the connected gaming devices 70, or other players, that one of the players of the connected gaming devices has won the bonus. In a preferred embodiment, the indicator that notifies that one of the players of the gaming devices 70 has won the bonus does not immediately identify the winning player. Instead, the bonus game 100 builds excitement by informing each of the players of the connected gaming devices 70 that they may have won the bonus 100. Then the bonus 100 enters an identification phase, where the winning player is identified. Examples of identifying the winner and determining the winning bonus award are described in related co-pending U.S. patent application Ser. No. ______, filed ______, entitled BONUS FOR CONNECTED GAMING DEVICES, (attorney docket 1351-0068), the teachings of which are incorporated herein by reference. Examples of possible bonuses include cash, credits, comps, food, free or reduced tickets, game hints, game controls, etc., as described in U.S. patent application Ser. No. 12/166,156, filed Jul. 1, 2008, entitled PLAYER BASED COMPENSATION and incorporated by reference herein.

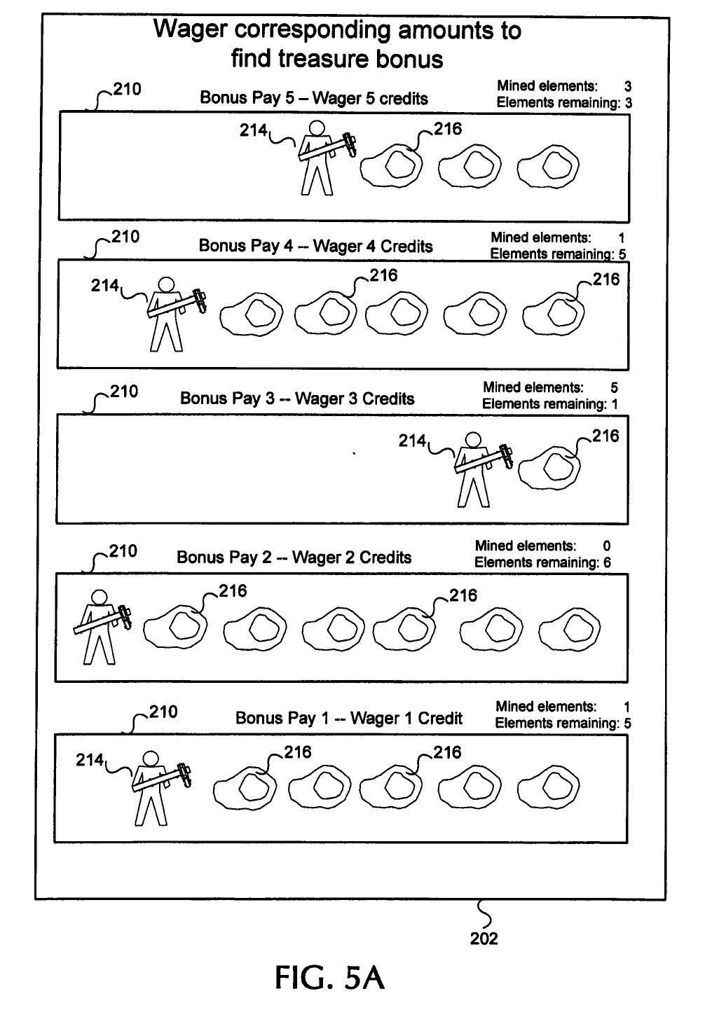

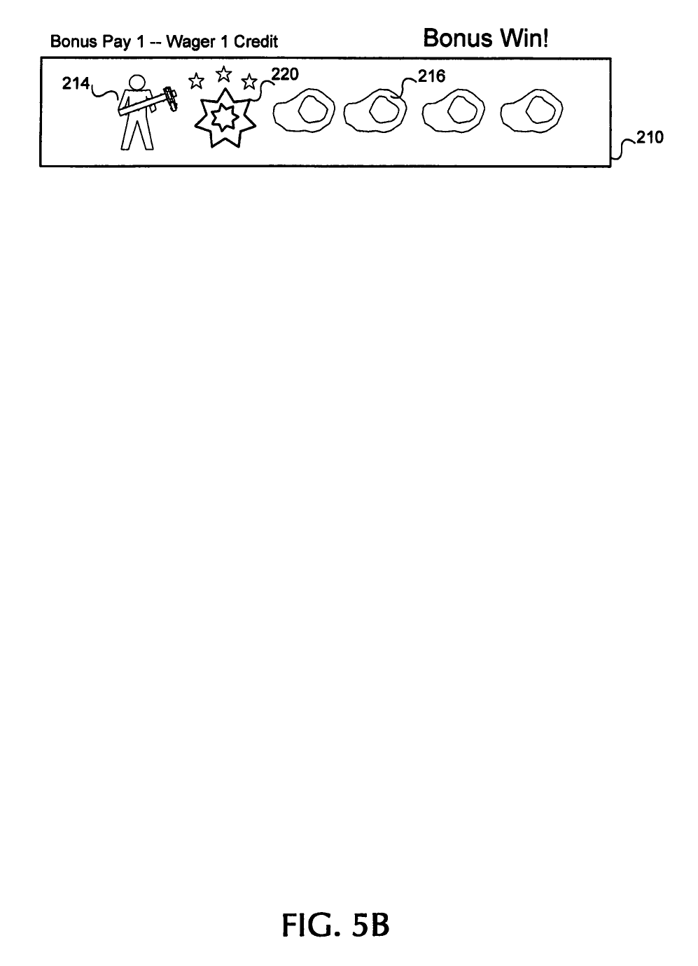

FIG. 5A illustrates a bonus game that provides another implementation of graphical feedback to a player so that the player can visually see his or her progress toward winning a bonus. In FIG. 5A a bonus window 202 is displayed on the EGM 10 (FIG. 1A), and specifically may be displayed on an LCD screen in the top box 18. Similar to the bonus screen 102 of FIG. 4, the bonus screen 202 is divided into five frames 210. Each of the frames 210 is an independent indication of progress toward a particular bonus pay. For example, wagering four credits with the bet-4 button 132 (FIG. 4) causes a movable icon, in this case a miner 214, to take action. In this embodiment, the miner swings a pickaxe at an element 216 having unknown contents. Although each wager by the player causes the miner 214 to animate, it may take multiple swings of the miner's pick to open the element 216. At least one of the elements 216 of each bonus frame 210 will hold a winning element described below.

Although up to six elements 216 are illustrated in each frame 210 of FIG. 5A, each frame may actually include any number of elements. Illustrating too few elements 216 may cause frustration with the user as multiple actions of the miner 214 are required to open each element 216. Conversely, having too many elements 216 within a bonus frame 210 may be too crowded and visually unappealing.

Further, each bonus frame 210 of FIG. 5A may include a text and/or character representation of how many elements have been already mined and how many elements are remaining. For example, with reference to the Bonus Pay 5 of FIG. 5A, the player is provided textual notice that the miner 214 has mined three of the possible six elements 216.

As described above with reference to FIG. 4, the bonus window 202 may appear identical for each of the linked games 70 or, each of the linked games 70 may include its own independently operating bonus window 202 that is specific for the player of that particular device.

With reference to FIG. 5B, play continues on the bonus system 100 until a player makes a wager that triggers the respective bonus. Triggering the bonus is graphically illustrated by the miner 214 uncovering a winning element 220, illustrated as a star or diamond in FIG. 5B. Uncovering the winning element 220 is a visual indication to the player that one of the players of the linked gaming devices 70 has won the bonus, but the player does not necessarily know which of the players of the linked devices has won the bonus. Identifying the winning player and determining the amount or type of bonus to be paid may be carried out in the manner described by the patent application incorporated by reference above. The amount won by the player can be graphically represented by having the miner uncover different colors or sizes of winning elements 220. For example, a red ruby may indicate a relatively low bonus amount while a clear diamond may indicate a top bonus award. Top awards may be reserved for max bets.

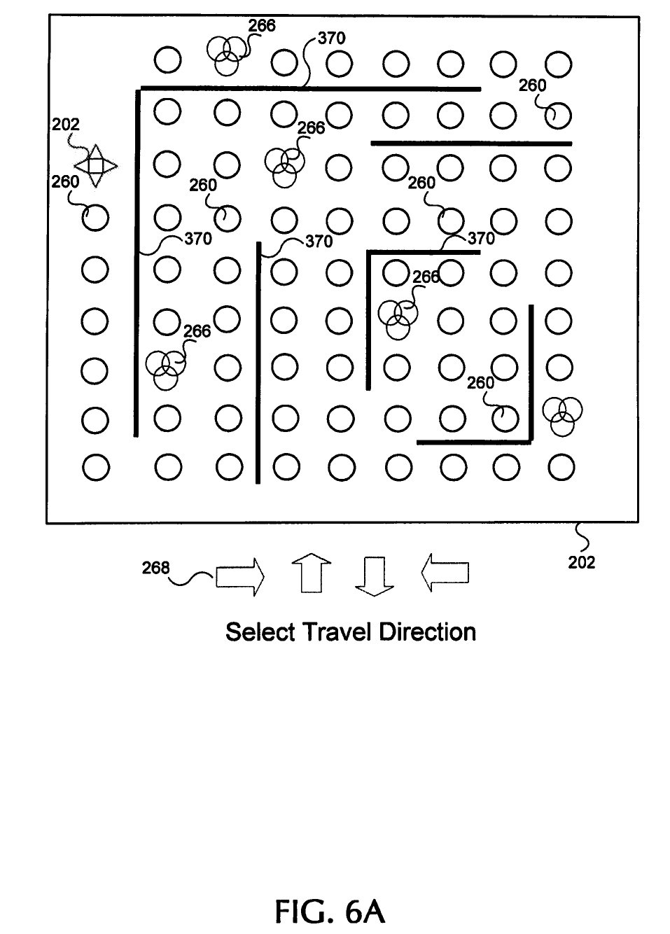

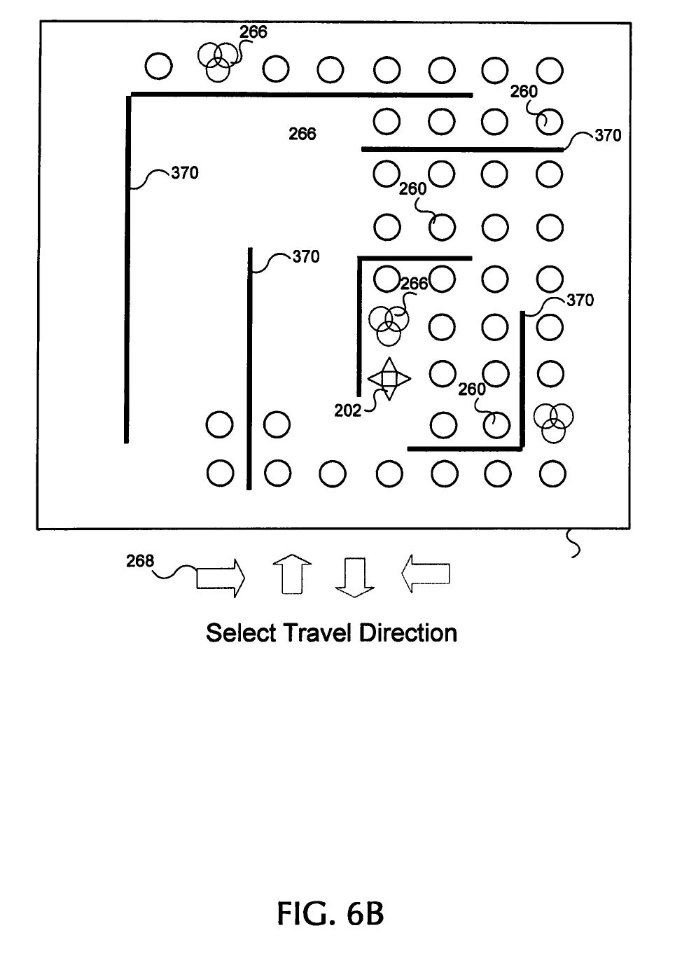

FIG. 6A illustrates yet another graphical representation of progress toward the bonus for a player of a gaming device 10 or a linked gaming device 70. In FIG. 6A, a bonus window 252 is illustrated, that can be, for example, shown on a screen in the top box 18 of gaming device 10 (FIG. 1A) or elsewhere on the gaming device. In this embodiment, an icon 256 sequentially eliminates one or more progress elements 260 on a path toward a winning element 266. In general, nothing happens when the icon 256 eliminates one of the progress elements 260, other than the progress element being removed from the bonus screen 252 and the icon 256 taking the place of the progress element. In this way, progress towards the bonus is shown to the player.

Like the bonus games described above, the icon 256 may remove progress elements 260 for a variety of reasons. In some embodiments the icon 256 may eliminate progress elements 260 simply based on the player making a particular wager, such as removing a progress element for each bet-2 wager or any bet-x wager. In other embodiments the icon 256 removes progress elements based on results of the gaming device. For example, the icon 256 may advance by removing a progress element when a particular combination of characters appears on the video reels of the gaming device 10. In another example, the icon 256 may advance each time the player exceeds a threshold level in the underlying game. For instance, the bonus system 100 may eliminate one or more progress elements 260 only if the base game has a winning combination that pays back over five credits. Alternatively, the bonus system 100 could remove progress elements 260 when the game outcome is below such a threshold. In another scenario the bonus system 100 eliminates progress elements 260 when the player has a series of losing outcomes, for example three losses in a row. In still other embodiments, the bonus system 100 causes the icon 256 to advance only if the player plays greater than a threshold amount of credits. For instance, the icon 256 may not move at all unless the player wagers max-bet. In still further embodiments, the icon 256 may move only if the player has paid for such a privilege, such as by paying an extra credit on a particular game. In still other embodiments, the obstacles may be removed randomly, e.g., at random times, without reason and not based on any event other than the passing of time, which may benefit the player.

In the embodiment illustrated in FIG. 6A, the player is able to select the travel direction of the icon 256 by controlling direction buttons 268, provided the icon can move in such a direction. A series of blocking rails 270 are illustrated in the bonus window 252, and the icon 256 cannot move through a blocking rail. The travel direction may be “sticky”, that is, the icon will continue to move in the selected travel direction until changed, or, the bonus system 100 may request that the player select direction each time the icon 256 moves. In such an implementation an attempt to move the icon 256 in a direction that it cannot move is an invalid selection. For example, with reference to the icon 256 positioned as it is in FIG. 6A, the only valid travel directions for the icon are up or down.

In operation, the icon 256 progresses through the filed of process elements 260 toward a winning element 256. When the icon 256 reaches the winning element 256, the player “wins” a bonus. In actuality, winning the bonus is caused by triggering the bonus through the bonus system 100, but graphically appears as if the icon 256 reaching the winning element 256 was the cause of the win. In embodiments played on linked machines 70, the icon 256 could indicate that any of the players of the linked devices has won the bonus. Methods of identifying and awarding the winning player have been described above, and this system can use any of such disclosed methods.

With reference to FIG. 6B, many of the progress elements 260 have been eliminated, which indicates the player is closer to the bonus. A winning element 266 may have a different physical appearance from a progress element 260, such as in FIG. 6B where progress elements 260 are open circles and the winning element 266 is a set of three interconnected circles. In some embodiments winning elements 260 can be “cloaked” to appear as progress elements 250 to make a secret bonus.

In the bonus window 252 of FIG. 6B, the icon 256 will uncover a winning element 266 in the next “up” move, provided the icon 256 moves in that direction. If the icon 256 is under player control the player will likely selects the up direction to win the bonus. The winning elements 266 can indicate particular bet-x bonuses, such as those described above. In one embodiment, each of the bet-x wagers appears within the bonus window 252 a single time. In other words, there is one bonus for each of the bet-1, bet-2, bet-3 wagers, etc. In other embodiments there may be multiple bonus awards for particular wagers. For example, there may be five bet-1 bonus awards in the bonus window 252 while there may be only a single bet-2 award.

Similar to the bonus game described in FIGS. 4 and 5A, the bonus game described with reference to FIGS. 6A and 6B may be for a single player, a small subset of players, or a larger set of players playing on linked gaming devices 70. In the embodiment where only a few players are connected to the same bonus screen 252, action on any of the connected players may help their fellow players. For example, all players may work toward the goal of a particular icon 256 uncovering a particular winning element 266. Conversely, players could work against each other trying to prevent their neighboring players from uncovering a winning element 266.

In another embodiment, a player wins higher bonus awards as the player uncovers more winning elements 266. For example, uncovering one winning element wins the player the “Bonus Pay One” and uncovering a second winning element 266 wins the player the Bonus Pay Two.” Such bonus wins continue until all bonuses are won by the player. Bonus progress may be stored on a player account, described with reference to FIG. 3 above. In other embodiments, players lose their progress when they stop a gaming session.

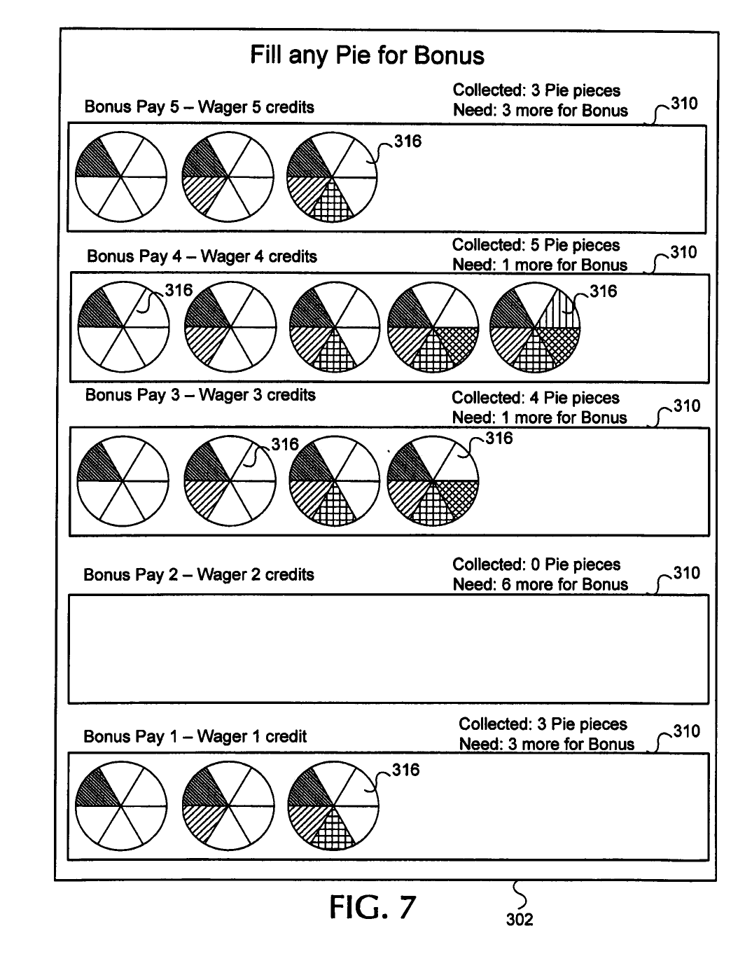

FIG. 7 illustrates a further graphical indicator to graphically illustrate to the player that he or she is getting closer to winning a bonus. In FIG. 7 a bonus window 302 includes one or more frames 310. In this example, each of the bet-x possibilities has a related frame 310, although it is not necessary that each wager possibility is separate. Progress toward the bonus is shown to the player by “filling” pie pieces, similar to the Trivial Pursuit™ game. In other words, wagers or other actions in the base game (or indeed, any of the actions described above with reference to FIGS. 6A and 6B) fill pie pieces. The bonus system 100 may require that the player completely fill a particular frame 310, that is, to accumulate all six pie pieces to win the bonus. In other embodiments, the bonus system 100 may trigger the bonus before all of the pie pieces are filled. Similar to the embodiment in FIG. 5A, 5B, because there are only six “events” of accumulating pie pieces possible, it may take multiple wagers or other game events to be awarded each pie piece. For example, the player may accumulate a first pie piece in the Bonus Pay 1 frame 310 for making 15 spins on the base game, and may accumulate a second pie piece based on a particular game result on the 25^{th} spin. Bonus winners and amounts are handled as described above.

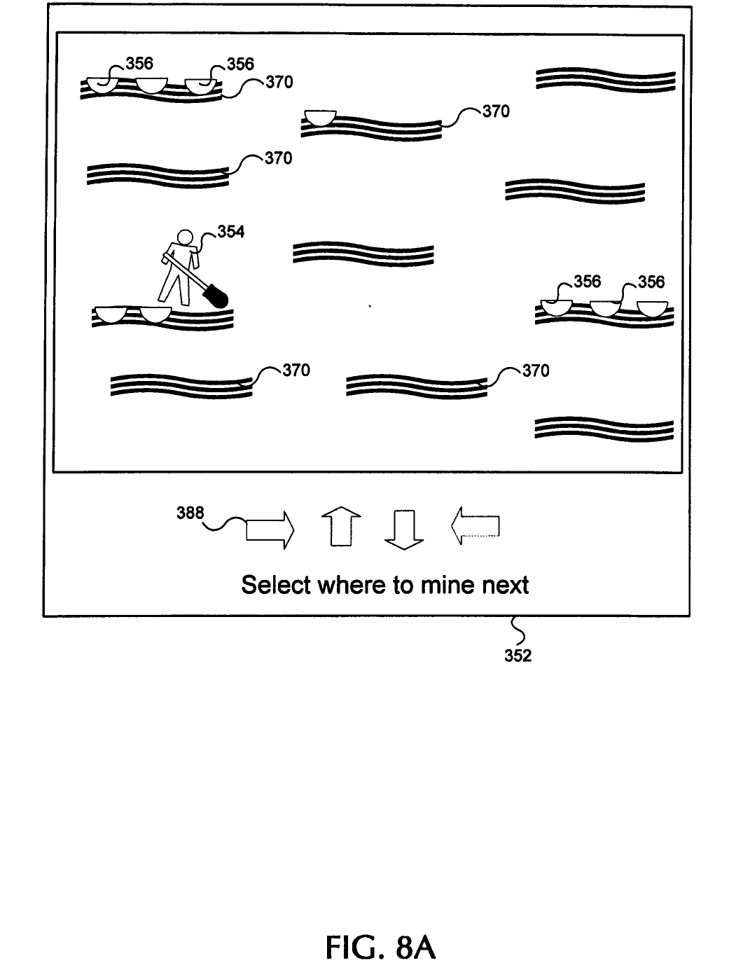

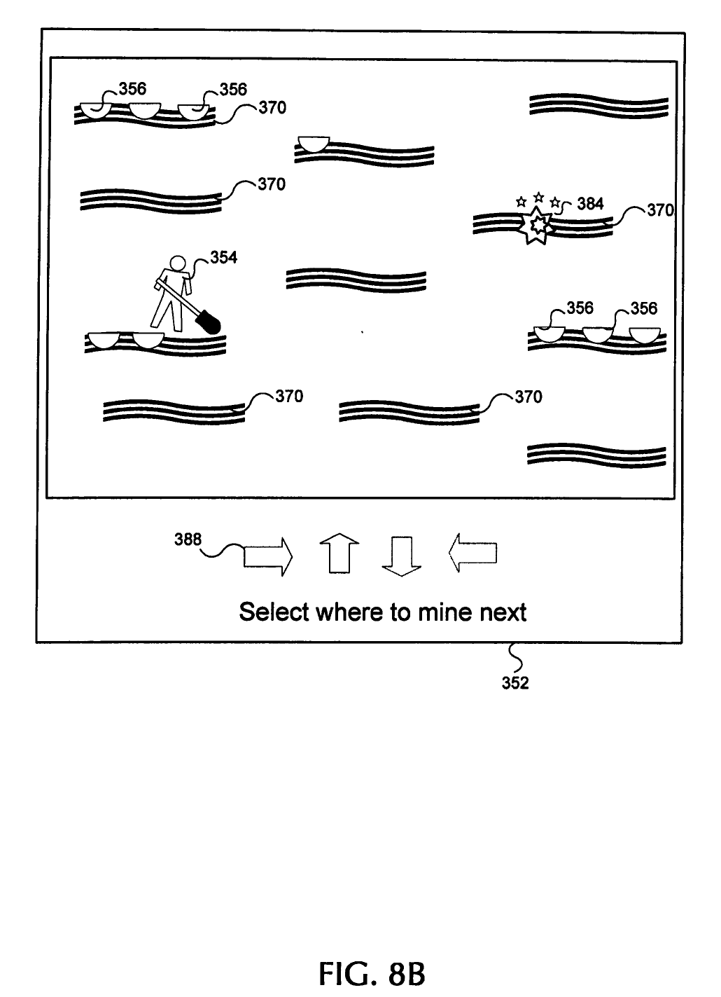

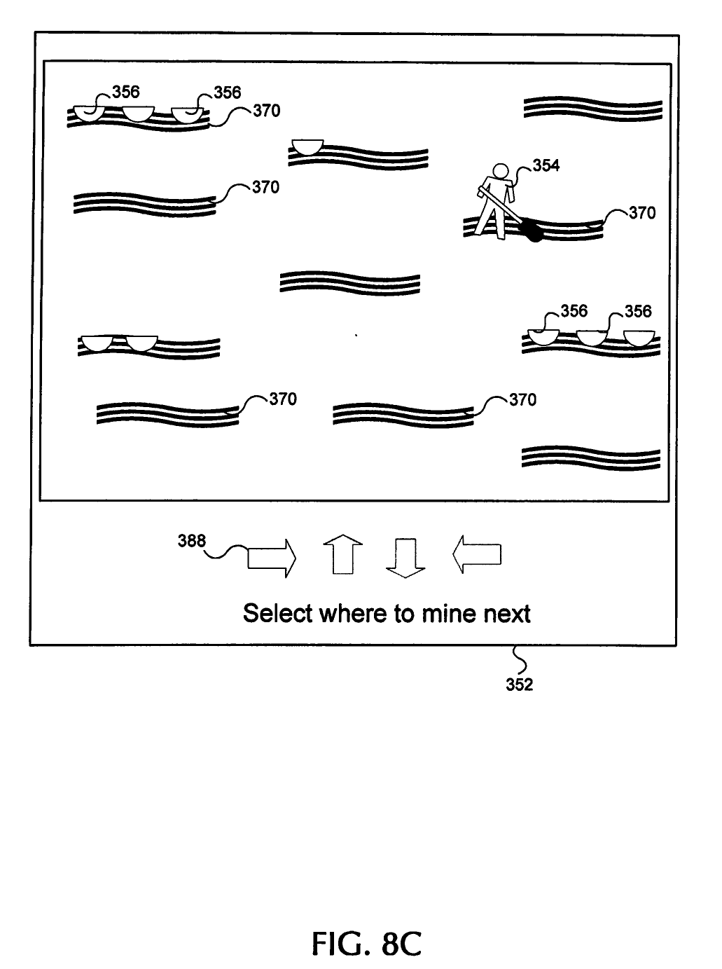

FIGS. 8A-8C, similar to the embodiment described with reference to FIGS. 6A and 6B above, provide the player with more opportunities for interaction with the graphical progress indicator. In FIG. 8A, a bonus screen 352 illustrates progress toward winning a bonus. The bonus screen 352 includes a panorama illustrating several mining locations 370. As illustrated, each mining location 370 includes one or more individual local mining sites 356. As the player plays the underlying base game, or based on a game event, a miner 354 digs a new local mining site 370 in one of the mining locations. The miner 354 may come up with an empty hole, or may mine a valuable reward. In practice the bonus screen 352 may include many more mining locations 370 and local mining sites 356 than are illustrated in FIG. 8A.

In some embodiments the bonus system 100 may reveal or partially reveal the location of a reward before the miner 354 discovers it. With reference to FIG. 8B, a reward 384 appears within one of the mining locations 370. The reward 384 may be shown to the player for only a brief time, or the bonus system 100 may cause the reward 384 to be continuously shown. In some embodiments the reward is revealed only if the player is playing a maximum bet, or otherwise gives value for the privilege of seeing the reward 384 location. In FIG. 8C, since the player knows the location of a reward, the player directs the miner 354 to the location 370 that contains the reward by using directional buttons 388. Then, as the player continues to play the base machine, the miner 354 uncovers the reward and the player wins the bonus. As with all of the bonus systems 100 described above, the bonus system 100 may operate in conjunction with multiple linked games 70. In any of the embodiments, the bonus screens, such as the bonus screen 352 may show common images for all of the connected players, or each player may play bonus games independently. Identifying the winning player, calculating the bonus amounts, and crediting those amounts to the winning player are all described above in the above-incorporated application (1351-068).

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out in the appended claims.

1. A bonus for a gaming device including a base game having winning and losing outcomes, the bonus comprising:
a bonus progress representation including a series of discrete indicators that are sequentially modified based at least in part by a game event.

2. The bonus of claim 1 in which sequentially modified comprises sequentially eliminated.

3. The bonus of claim 1 in which sequentially modified comprises sequentially added.

4. The bonus of claim 1 in which sequentially modified comprises sequentially animated.

5. The bonus of claim 1 in which the discrete indicators include non-winning indicators and winning indicators, and in which a bonus is awarded when a winning indicator is modified.

6. The bonus of claim 5 in which winning indicators can appear as non-winning indicators.

7. The bonus of claim 1 in which a bonus is awarded only when all indicators have been modified from the bonus progress representation.

8. The bonus of claim 1 in which one or more of the discrete indicators is modified based on a number of credits played on the base game.

9. The bonus of claim 1 in which one or more of the discrete indicators is modified only when a player of the base game makes a maximum bet.

10. The bonus of claim 1 in which one or more of the discrete indicators is modified based on when a player of the base game pays value for the indicator to be modified.

11. The bonus of claim 1 in which one or more of the discrete indicators is modified at random times without input from a player.

12. The bonus of claim 1 in which one or more of the discrete indicators is modified based on a number of losses of the base game.

13. The bonus of claim 12 in which one or more of the discrete indicators is modified based on a number of sequential losses of the base game.

14. The bonus of claim 1 in which bonus progress data is stored in conjunction with a player account.

15. The bonus of claim 1 in which game play from a base game of another gaming device affects the bonus progress indicator.

16. The bonus of claim 12 in which game play from a base game of the other gaming device causes one of the discrete indicators to be modified.

17. The bonus progress indicator of claim 1 in which the bonus comprises a free spin.

18. The bonus progress indicator of claim 1 in which the bonus comprises a temporary multiplier for multiplying payback from the base game.

19. A bonus for a collection of connected gaming devices, comprising:
an initiation stage in which progress toward the bonus is graphically shown by displaying a series of discrete indicators to predetermined players of the connected gaming devices;
an identification stage in which, when a bonus trigger has been satisfied, the predetermined players are notified that the bonus has been triggered by an unidentified player; and
a bonus awarding stage in which one of the predetermined players receives a benefit.

20. The bonus of claim 19 in which the bonus is awarded to the player who satisfied the bonus trigger.

21. The bonus of claim 19 in which the predetermined players are identified players.

22. The bonus of claim 19 in which game actions of the predetermined players contribute toward a level known to the predetermined players at which the bonus trigger is certain to be satisfied.

23. The bonus of claim 19, further comprising, during the identification stage, a notice that any of the predetermined players may have satisfied the bonus trigger.

24. The bonus of claim 19 in which at least one previously satisfied trigger level is displayed to the predetermined players.

25. A method of providing a bonus to a player of a gaming device having a base game, comprising:
on a display, generating a present-position icon and a representation of a bonus reward;
generating a series of obstacles between the position icon and the reward representation, each of the series of obstacles representing one or more events at least partially based on base game events;
removing one or more of the obstacles when an obstacle-removing event occurs; and
awarding a bonus to the player based on an obstacle removing event.

26. The method of claim 25 in which player progress toward the bonus reward is stored on a player account and available in a subsequent gaming session.

27. The method of claim 25 in which, when the player is an unidentified player, player progress starts new with each gaming session.

28. The method of claim 25, further comprising removing one or more of the obstacles when an obstacle removing event occurs at a second gaming device coupled to the gaming device.

29. The method of claim 25, in which removing one or more of the obstacles when an obstacle-removing event occurs comprises:
removing one or more of the obstacles when the player pays value to have an obstacle removed.

30. The method of claim 25, in which removing one or more of the obstacles when an obstacle-removing event occurs comprises:
removing one or more of the obstacles based on a particular base game outcome.

31. The method of claim 25 in which the obstacles are unopened rocks and in which the reward representation is a jewel extracted from one of the rocks.

32. The method of claim 25 in which the obstacles are filled holes and in which the reward representation is a jewel extracted from one of the holes.

33. The method of claim 25 in which the obstacles are markers and in which the reward representation are markers having a different appearance than the obstacles.

34. The method of claim 25 in which the obstacles are markers and in which the reward representation are markers having the same as the obstacles.
